(19) United States
(12) Patent Application Publication
(10) Pub. No.: US 2020/0080403 A1
(43) Pub. Date: Mar. 12, 2020

(54) Control of Proppant Redistribution During Fracturing

(71) Applicant: LANDMARK GRAPHICS CORPORATION, Houston, TX (US)

(72) Inventors: Andrey FILIPPOV, Houston, TX (US); Jianxin LU, Bellaire, TX (US); Florentina POPA, Houston, TX (US)

(73) Assignee: Landmark Graphics Corporation, Houston, TX (US)

(21) Appl. No.: 16/348,399

(22) PCT Filed: Dec. 19, 2016
(86) PCT No.: PCT/US2016/067581

§ 371 Date: May 8, 2019

(51) Int. Cl. E21B 41/00; E21B 43/267; E21B 47/10; G01V 99/00; C09K 8/80; C09K 8/62

(52) U.S. Cl. CPC E21B 41/0092; E21B 43/267; C09K 8/62; G01V 99/005; C09K 8/80; E21B 47/10

(57) ABSTRACT

A variety of systems and methods are disclosed. A method may comprise calculating fluid flow with a computer system, wherein the fluid flow is a flow of a fracturing fluid comprising proppant; calculating dimensionless parameters with the computer system, wherein the dimensionless parameters comprise a description of a local flow around an individual perforated exit from a wellbore to a fracture; determining proppant collection efficiency using pre-calculated data with the computer system; calculating a proppant flow rate to the fracture with the computer system; and calculating with the computer system , an amount of the proppant delivered to the fracture based on the dimensionless parameters, the proppant collection efficiency, and the proppant flow rate to the fracture.

### BACKGROUND

Fracturing treatments are commonly used in subterranean operations, among other purposes, to stimulate the production of desired fluids (e.g., oil, gas, water, etc.) from a subleterranean formation. For example, hydraulic fracturing treatments generally involve pumping a treatment fluid (e.g., a fracturing fluid) into a well bore that penetrates a subterranean formation at a sufficient hydraulic pressure to create or enhance one or more fractures in the subterranean formation. The creation and/or enhancement of these fractures may enhance the production of fluids from the subterranean formation.

In order to maintain and/or enhance the conductivity of a fracture in a subterranean formation, proppant may be deposited in the fracture, for example, by introducing a high viscosity fracturing fluid carrying those proppant into the subterranean formation. The proppant may prevent the fractures from fully closing upon the release of hydraulic pressure, forming conductive channels through which fluids may flow to the wellbore.

Flow models have been used to simulate fluid flow in hydraulic fracturing treatments and other environments. Flow models may be used to simulate the flow of the proppant, for example, within a fracture network.

### BRIEF DESCRIPTION OF THE DRAWINGS

These drawings illustrate certain aspects of the present disclosure, and should not be used to limit or define the disclosure.

FIG. 1 is a schematic view of an example simulated well system utilized for hydraulic fracturing.

FIG. 2 is a schematic view of an example of a simulated wellbore after introduction of fracturing fluid.

FIG. 3 illustrates an example of a proppant force analysis.

FIG. 4 illustrates the dependence R (Λ) calculated for various values of a Stokes number.

FIG. 5 illustrates an example algorithm utilizing a computer system.

FIG. 6 illustrates an example computer system.

### DETAILED DESCRIPTION

The present disclosure may relate to subterranean operations, and, in one or more implementations, to fluid flow models utilized to analyze fluid flow during subterranean operations, such as, for example, hydraulic fracturing. More specifically, the present disclosure may relate to systems and methods for predicting particle flow rates to individual fractures based on pre-calculated dependencies of proppant collection efficiency on dimensionless parameters describing a local flow around an individual perforated exit from a wellbore. Proppant collection efficiency may be a parameter that measures a concentration difference between locations at a pipe inlet and inside a perforation. It may be defined as R in Equation (3), as shown below. In many cases, perforations may have less proppant intake at the inlet; a large portion of proppant particles may not enter into the perforation. This scenario may be defined as low proppant collection efficiency. The maximum ratio of proppant flow rate to the perforation to flow rate of proppant in wellbore may be evaluated as the ratio of flow rate of the carrier fluid to the perforation to that in the wellbore. The proppant collection efficiency may be the ratio of the actual flow rate to the perforation to its maximum value. If proppant is “frozen” in the carrier fluid and moves along the fluid's streamlines, the collection efficiency may equal 1.

Perforations may connect the fractures to the wellbore. Because the flow conditions around each of the perforations may be different, the amount of proppant carried to each fracture may vary. The proppant inertia may also be taken into account for high flow rates and small diameters of the perforations, when the proppant does not follow the flow streamlines and the efficiency of proppant delivery to fractures decreases.

In some environments, the fluid (e.g., fracturing fluid) flow may be unsteady and multi-dimensional (e.g., three-dimensional or at least two-dimensional). For example, in some types of fractures, a dominant flow may be two-dimensional and may include transient behaviors. Without limitation, two- or three-dimensional flow may be described by a one-dimensional flow model, for example, by integrating the governing flow equations over the cross-section of the two- or three-dimensional flow path. Alternatively, resulting equations may include nonlinear partial differential equations that may be solved using finite difference, finite volume, and/or finite element methods. The use of one-dimensional flow models may reduce computational costs, and may allow for faster or more computationally efficient simulations. Additionally, a flow model may be used to perform numerical simulations in real time, for example, during a fracture treatment or during another well system activity.

Without limitation, a fluid flow model may model a flow of fluid in a fracture, for example, during a hydraulic fracturing treatment or another type of injection treatment. As another example, a fluid flow model may model a flow and distribution of proppant in a fracture. Hydraulic fracturing treatment with proppant may improve the conductivity of a hydrocarbon reservoir, and modeling the hydraulic fracturing treatment, including proppant transport, may help to efficiently design, analyze, and/or optimize the treatment. Without limitation, a hydraulic fracturing model may combine simulations of fracture propagation, rock deformation, fluid flow, proppant transport, and other phenomena. The fluid flow models of the present disclosure may be utilized to account for complex physical conditions of the subterranean formation.

In hydraulic fracturing treatments, proppant may play an important role by preventing the closure of fractures, and thus, may improve the production from a fracture-stimulated reservoir. The proppant may be delivered to individual fractures by a fracturing fluid, which may include an aqueous based fluid and/or additives (e.g., gelling agents) to increase viscosity of the fracturing fluid and reduce the particle sedimentation by gravity.

An aqueous based fluid may include fresh water or salt water. The term “salt water” is used herein to mean unsaturated salt solutions and saturated salt solutions including brines and seawater. Generally, salt may be added to the water to provide clay stability and to increase the density of the aqueous based fluid. Examples of salts that can be used include, but are not limited to, sodium chloride, sodium bromide, calcium chloride, potassium chloride, ammonium chloride and mixtures thereof. Without limitation, the salt or salts used can be present in the salt water in a concentration up to about 66% by weight thereof and the salt water can have a density up to about 15.5 pounds per gallon. The amount of water in the fracturing fluid may be up to about 80% to about 99.9%, depending on the concentration of salt and additives.

Gelling agents may be included in the fracturing fluid to increase the fracturing fluid's viscosity which may be desired for a number of reasons in subterranean applications. For example, an increase in viscosity may be used for transferring hydraulic pressure to divert treatment fluids to another part of a formation or for preventing undesired leak-off of fluids into a formation from the buildup of filter cakes. The increased viscosity of the gelled or gelled and cross-linked treatment fluid, among other things, may reduce fluid loss and may allow the fracturing fluid to transport significant quantities of suspended proppant particulates. Gelling agents may include, but are not limited to, any suitable crosslinkable polymer, including, but not limited to, galactomannan gums, cellulose derivatives, combinations thereof, derivatives thereof, and the like. Galactomannan gums are generally characterized as having a linear mannan backbone with various amounts of galactose units attached thereto. Examples of suitable galactomannan gums include, but are not limited to, gum arabic, gum ghatti, gum karaya, tamarind gum, tragacanth gum, guar gum, locust bean gum, combinations thereof, derivatives thereof, and the like. Other suitable gums include, but are not limited to, hydroxyethylguar, hydroxypropylguar, carboxymethylguar, carboxymethylhydroxyethylguar and carboxymethylhydroxypropylguar. Examples of suitable cellulose derivatives include hydroxyethyl cellulose, carboxyethylcellulose, carboxymethylcellulose, and carboxymethylhydroxyethylcellulose; derivatives thereof, and combinations thereof. The crosslinkable polymers included in the treatment fluids of the present disclosure may be naturally-occurring, synthetic, or a combination thereof. The crosslinkable polymers may comprise hydratable polymers that contain one or more functional groups such as hydroxyl, cis-hydroxyl, carboxyl, sulfate, sulfonate, phosphate, phosphonate, amino, or amide groups. In certain systems and/or methods, the crosslinkable polymers may be at least partially crosslinked, wherein at least a portion of the molecules of the crosslinkable polymers are crosslinked by a reaction comprising a crosslinking agent. The amount of gelling agent within the fracturing fluid may range from about 5 lbs/1,000 gal to about 60 lbs/1,000 gal. Additionally, the amount of gelling agent may be up to 200 lbs/1,000 gal; however, if a low molecular weight material is used, the amount of gelling agent may exceed 200 lbs/1,000 gal.

Typically, the proppant may include a collection of solid particles that may be injected into the subterranean formation, such that the solid particles hold (or “prop”) open the fractures generated during a hydraulic fracturing treatment. The proppant may include a variety of solid particles, including, but not limited to, sand, bauxite, ceramic materials, glass materials, polymer materials, polytetrafluoroethylene materials, nut shell pieces, cured resinous particulates comprising nut shell pieces, seed shell pieces, cured resinous particulates comprising seed shell pieces, fruit pit pieces, cured resinous particulates comprising fruit pit pieces, wood, composite particulates, and combinations thereof. Suitable composite particulates may comprise a binder and a filler material wherein suitable filler materials include silica, alumina, fumed carbon, carbon black, graphite, mica, titanium dioxide, meta-silicate, calcium silicate, kaolin, talc, zirconia, boron, fly ash, hollow glass microspheres, solid glass, and combinations thereof. Without limitation, the proppant may comprise graded sand. Other suitable proppant that may be suitable for use in subterranean applications may also be useful. Without limitation, the proppant may have a particle size in a range from about 2 mesh to about 400 mesh, U.S. Sieve Series. By way of example, the proppant may have a particle size of about 10 mesh to about 70 mesh with distribution ranges of 10-20 mesh, 20-40 mesh, 40-60 mesh, or 50-70 mesh, depending, for example, on the particle sizes of the formation particulates to be screen out. The proppant may be carried by the fracturing fluid. Without limitation, the proppant may be present in the fracturing fluid in a concentration of about 0.1 pounds per gallon (“ppg”) to about 10 ppg, about 0.2 ppg to about 6 ppg. These ranges encompass every number in between, for example. For example, the concentration may range between about 0.5 ppg to about 4 ppg. One of ordinary skill in the art with the benefit of this disclosure should be able to select an appropriate amount of the proppant composition to use for a particular application.

Without limitation, a curable resin may be coated or otherwise disposed on the proppant. Inclusion of the curable resin on the proppant may fill the fractures, providing an in-situ mechanical screen that can hold the proppant in place while maintaining integrity of the well. Curable resins suitable for use with the proppant may include any resin that is capable of forming a hardened, consolidated mass. Many such curable resins are commonly used in consolidation treatments, and some suitable curable resins may include, without limitation, two component epoxy based resins, novolak resins, polyepoxide resins, phenol-aldehyde resins, urea-aldehyde resins, urethane resins, phenolic resins, furan resins, furan/furfuryl alcohol resins, phenolic/latex resins, phenol formaldehyde resins, polyester resins and hybrids and copolymers thereof, polyurethane resins and hybrids and copolymers thereof, acrylate resins, and mixtures thereof. Some suitable curable resins, such as epoxy resins, may be cured with an internal catalyst or activator so that when pumped downhole, they may be cured using only time and temperature. Other suitable curable resins, such as furan resins may generally require a time-delayed catalyst or an external catalyst to help activate the polymerization of the resins if the cure temperature is low (i.e., less than about 250° F.) but may cure under the effect of time and temperature if the formation temperature is above about 250° F., preferably above about 300° F. The amount of curable resin may be from about 0.5% to about 5% v/w with respect to the proppant.

Selection of a suitable curable resin may be affected by the temperature of the subterranean formation to which the proppant may be introduced. By way of example, for a subterranean formation having a bottom hole static temperature (“BHST”) ranging from about 60° F. to about 250° F., two component epoxy based resins comprising a hardenable resin component and a hardening agent component may be preferred. For a subterranean formation having a BHST ranging from about 300° F. to about 600° F., a furan based resin may be preferred, for example For a subterranean formation having a BHST ranging from about 200° F. to about 400° F., either a phenolic based resin or a one component HT epoxy based resin may be suitable, for example For a subterranean formation having a BHST of at least about 175° F., a phenol/phenol formaldehyde/furfuryl alcohol resin may also be suitable, for example With the benefit of this disclosure, one of ordinary skill in the art should be able to recognize and select a suitable resin for use in consolidation treatment applications.

Additionally the fracturing fluid may comprise any number of additional additives, including, but not limited to, salts, acids, fluid loss control additives, gas, foamers, corrosion inhibitors, catalysts, friction reducers, antifoam agents, bridging agents, dispersants, flocculants, H₂S scavengers, CO₂ scavengers, oxygen scavengers, lubricants, weighting agents and any combination thereof With the benefit of this disclosure, one of ordinary skill in the art should be able to recognize and select suitable additives for use in the fracturing fluid.

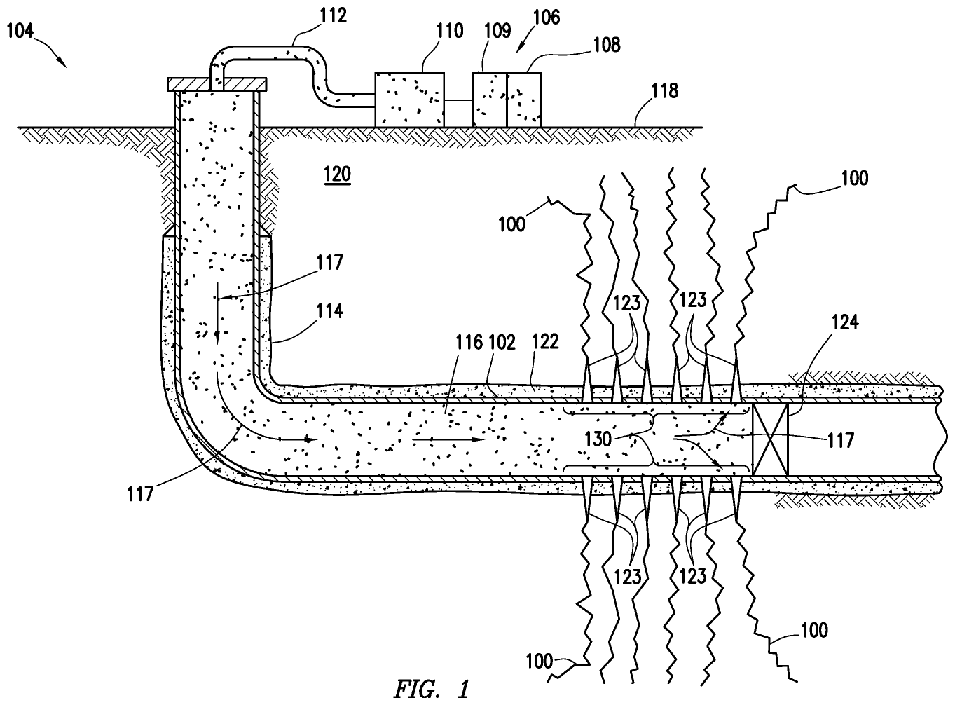

FIG. 1 illustrates an example of a simulated well system 104 (e.g., wellbore simulation utilizing a wellbore simulator) that may be used to introduce proppant 116 into fractures 100. The simulated well system 104 may include a fluid handling system 106, which may include fluid supply 108, mixing equipment 109, pumping equipment 110, and wellbore supply conduit 112. Pumping equipment 110 may be fluidly coupled with the fluid supply 108 and wellbore supply conduit 112 to communicate a fracturing fluid 117, which may comprise proppant 116 into wellbore 114. The fluid supply 108 and pumping equipment 110 may be above the surface 118 while the wellbore 114 is below the surface 118,

The simulated well system 104 may also be used for the injection of a pad or pre-pad fluid into the subterranean formation at an injection rate at or above the fracture gradient to create at least one fracture 100 in subterranean formation 120. The simulated well system 104 may then inject the fracturing fluid 117 into subterranean formation 120 surrounding the wellbore 114. Generally, a wellbore 114 may include horizontal vertical, slanted, curved, and other types of wellbore geometries and orientations, and the proppant 116 may generally be applied to subterranean formation 120 surrounding any portion of wellbore 114, including fractures 100. The wellbore 114 may include the casing 102 that may be cemented (or otherwise secured) to the wall of the wellbore 114 by cement sheath 122. Perforations 123 may allow communication between the wellbore 114 and the subterranean formation 120. As illustrated, perforations 123 may penetrate casing 102 and cement sheath 122 allowing communication between interior of casing 102 and fractures 100. A plug 124, which may be any type of plug for oilfield applications (e.g., bridge plug), may be disposed in wellbore 114 below the perforations 123.

In accordance with systems and/or methods of the present disclosure, a perforated interval of interest 130 (depth interval of wellbore 114 including perforations 123) may be isolated with plug 124. A pad or pre-pad fluid may be injected into the subterranean formation 120 at an injection rate at or above the fracture gradient to create at least one fracture 100 in subterranean formation 120. Then, proppant116 may be mixed with an aqueous based fluid via mixing equipment 109, thereby forming a fracturing fluid 117, and then may be pumped via pumping equipment 110 from fluid supply 108 down the interior of casing 102 and into subterranean formation 120 at or above a fracture gradient of the subterranean formation 120. Pumping the fracturing fluid 117 at or above the fracture gradient of the subsurface formation 120 may create (or enhance) at least one fracture (e.g., fractures 100) extending from the perforations 123 into the subterranean formation 120. Alternatively, the fracturing fluid 117 may be pumped down production tubing, coiled tubing, or a combination of coiled tubing and annulus between the coiled tubing and the casing 102.

At least a portion of the fracturing fluid 117 may enter the fractures 100 of subterranean formation 120 surrounding wellbore 114 by way of perforations 123. Perforations 123 may extend from the interior of casing 102, through cement sheath 122, and into subterranean formation 120.

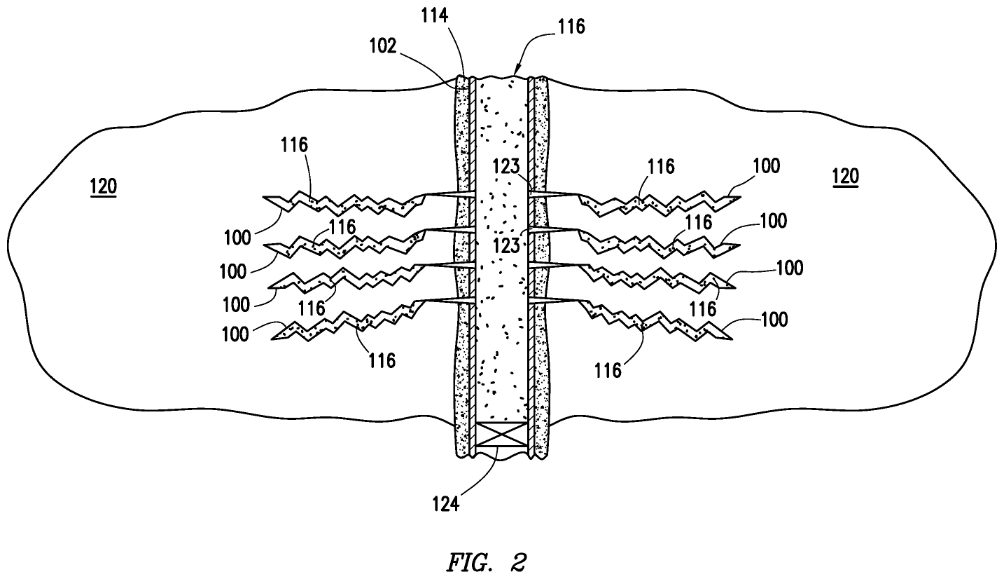

Referring to FIG. 2, the wellbore 114 is shown after placement of the proppant 116 in accordance with systems and/or methods of the present disclosure. Proppant 116 may be positioned within fractures 100, thereby propping open fractures 100.

The pumping equipment 110 may include a high pressure pump. As used herein, the term “high pressure pump” refers to a pump that is capable of delivering the fracturing fluid 117 and/or pad/pre-pad fluid downhole at a pressure of about 1000 psi or greater. A high pressure pump may be used when it is desired to introduce the fracturing fluid 117 and/or pad/pre-pad fluid into subterranean formation 120 at or above a fracture gradient of the subterranean formation 120, but it may also be used in cases where fracturing is not desired. Additionally, the high pressure pump may be capable of fluidly conveying particulate matter, such as the proppant116, into the subterranean formation 120. Suitable high pressure pumps may include, but are not limited to, floating piston pumps and positive displacement pumps. Without limitation, the initial pumping rates of the pad fluid, pre-pad fluid and/or fracturing fluid 117 may range from about 15 barrels per minute (“bbl/min”) to about 80 bbl/min, enough to effectively create a fracture into the formation and place the proppant 116 into at least one fracture 101.

Alternatively, the pumping equipment 110 may include a low pressure pump. As used herein, the term “low pressure pump” refers to a pump that operates at a pressure of about 1000 psi or less. A low pressure pump may be fluidly coupled to a high pressure pump that may be fluidly coupled to a tubular (e.g., wellbore supply conduit 112). The low pressure pump may be configured to convey the fracturing fluid 117 and/or pad/pre-pad fluid to the high pressure pump. The low pressure pump may “step up” the pressure of the fracturing fluid 117 and/or pad/pre-pad fluid before it reaches the high pressure pump.

Mixing equipment 109 may include a mixing tank that is upstream of the pumping equipment 110 and in which the fracturing fluid 117 may be formulated. The pumping equipment 110 (e.g., a low pressure pump, a high pressure pump, or a combination thereof) may convey fracturing fluid 117 from the mixing equipment 109 or other source of the fracturing fluid 117 to the casing 102. Alternatively, the fracturing fluid 117 may be formulated offsite and transported to a worksite, in which case the fracturing fluid 117 may be introduced to the casing 102 via the pumping equipment 110 directly from its shipping container (e.g., a truck, a railcar, a barge, or the like) or from a transport pipeline. In either case, the fracturing fluid 117 may be drawn into the pumping equipment 110, elevated to an appropriate pressure, and then introduced into the casing 102 for delivery downhole.

The exemplary fracturing fluid disclosed herein may directly or indirectly affect one or more components or pieces of equipment associated with the preparation, delivery, recapture, recycling, reuse, and/or disposal of the fracturing fluid. For example, the fracturing fluid may directly or indirectly affect one or more mixers, related mixing equipment, mud pits, storage facilities or units, composition separators, heat exchangers, sensors, gauges, pumps, compressors, and the like used generate, store, monitor, regulate, and/or recondition the sealant composition. The fracturing fluid may also directly or indirectly affect any transport or delivery equipment used to convey the fracturing fluid to a well site or downhole such as, for example, any transport vessels, conduits, pipelines, trucks, tubulars, and/or pipes used to compositionally move the fracturing fluid from one location to another, any pumps, compressors, or motors (e.g., topside or downhole) used to drive the fracturing fluid into motion, any valves or related joints used to regulate the pressure or flow rate of the fracturing fluid, and any sensors (i.e., pressure and temperature), gauges, and/or combinations thereof, and the like. The disclosed fracturing fluid may also directly or indirectly affect the various downhole equipment and tools that may come into contact with the fracturing fluid such as, but not limited to, wellbore casing, wellbore liner, completion string, insert strings, drill string, coiled tubing, slickline, wireline, drill pipe, drill collars, mud motors, downhole motors and/or pumps, cement pumps, surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like.

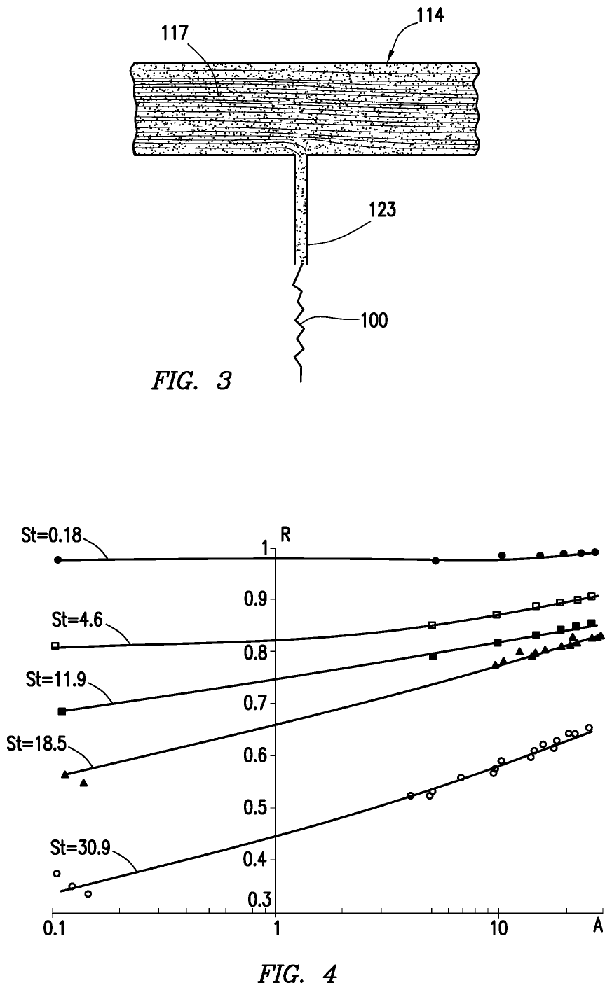

FIG. 3 illustrates an example of a proppant particle force analysis, which may include a section of wellbore 114 containing an outlet (e.g., perforation 123). For this analysis, the perforation 123 may be modeled as a circular pipe of a smaller diameter (e.g., 1/10 or less of that of the wellbore 114). The fracturing fluid 117 and its flow into perforation 123 is represented on FIG. 3 by the illustrated streamlines. Proppant 116 (e.g., shown on FIG. 1) may have different trajectories than fracturing fluid 117. If Q_{lw} and Q_{lf} are the mass flow rates of the fracturing fluid 117 in the wellbore 114, and fracture 100, respectively, their ratio Πₗ is:

$${\prod }_{l} = \frac{{Q}_{lf}}{{Q}_{lw}} \qquad ( 1 )$$

Similarly, the ratio of the particle mass flow rates in the wellbore Q_{pw}, and fracture Q_{pf} is:

$${\prod }_{p} = \frac{{Q}_{pf}}{{Q}_{pw}} \qquad ( 2 )$$

The proppant collection efficiency R of proppant diversion to fracture 100 may be defined as:

$$R = \frac{{\prod }_{p}}{{\prod }_{l}} \qquad ( 3 )$$

In an ideal case, where (e.g., proppant 116 shown on FIG. 1) may move along the fracturing fluid's (e.g., fracturing fluid 117) streamlines, R=1. However, if particles' paths deviate from the liquid streamlines of fracturing fluid 117 because of their inertia or the action of external forces, R may no longer be equal to 1. In particular, in the case of a geometry shown in FIG. 3, the effect of particle inertia may be negative, and ratio R may be less than 1.

The dimension analysis may yield the following dimensionless parameters which may define a local 2-phase flow, as shown in FIG. 3.

$$St = \frac{2}{9} \frac{{ρ}_{p} {a}^{2} {V}_{w}}{μ {D}_{f}} ; Re = \frac{{ρ}_{w} {V}_{w} {D}_{w}}{μ} Λ = \frac{{V}_{f}}{{V}_{w}} ; Fr = \frac{{V}_{w}^{2}}{g {D}_{f}} ; η = \frac{{D}_{w}}{{D}_{f}} \qquad ( 5 )$$

where a is the particle radius, ρₚ and ρₗ are the particle and fluid density, respectively, μ is the fluid viscosity, V_{f} and V_{w} are the average fluid speed in the fracture 100 and wellbore 114, respectively, g is the gravity acceleration, D_{f} and D_{w} are the diameters of fracture 100 and wellbore 114, respectively, Fr is the Froude number, Re is the Reynolds number and St is the Stokes number. It may be assumed that the fracture diameter is small enough (e.g., 1/10 or less of that of the wellbore 114), so that the gravity effect on the particle motion near the junction is negligible.

In the case of non-Newtonian, power-law fluid, the viscosity may not be constant, and Equation 5 for the Stokes number may be generalized:

$$St = \frac{2}{9} \frac{{ρ}_{p} {a}^{n + 1} {V}_{p}^{2 - n}}{k n {D}_{f}} \qquad ( 6 )$$

The dependence of the proppant collection efficiency on the parameters St and Λ may be determined numerically by solving equations of particle and fluid motion with geometry of the fracture entrance area (e.g., perforation 123) as shown in FIG. 3.

FIG. 4 illustrates the dependence R(Λ) calculated for various values of a Stokes number in a simulated example Proppant collection efficiency R may be a function of the fracture-wellbore fluid flow rate ratio Λ calculated for different values of Stokes number in the case of a Newtonian fluid. The fluid flow rate ratio is a ratio of a flow rate of the fracturing fluid in the fracture versus a flow rate in the well bore. As expected, the efficiency may be close to 1 at low values of St, but may decrease monotonously with increasing St. Calculations performed for a range of pipe diameters and flow velocities showed weak effects of fracture-wellbore diameter ratio η and Reynolds number on the proppant collection efficiency. These results may imply that the proppant collection efficiency R can be considered depending only on the Stokes number and ratio of velocities A, provided the proppant concentration is low enough (e.g., less than about 10% by volume).

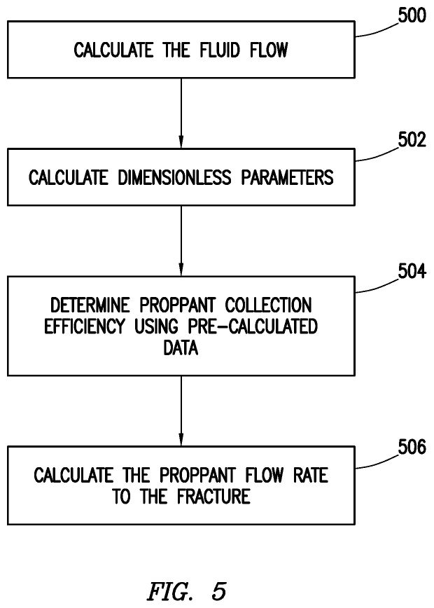

Referring now to FIG. 5, an algorithm is presented for calculating proppant 116 (e.g., shown on FIGS. 1 and 2) transport efficiency to the fractures 100 (e.g., shown on FIGS. 1 and 2). At box 500, the algorithm may include calculating the fluid flow. Fluid flow may be calculated, for example, using a computer system, such as, for example, a wellbore simulator (e.g., single phase wellbore simulator). Without limitation, the calculated fluid flow may include the flow of the fracturing fluid (e.g., fracturing fluid 117 shown on FIGS. 1 and 2), including the fluid flow rate and flow ratio Πₗ (Eq.1) to the fracture of interest (e.g., fractures 100 shown on FIGS. 1 and 2). At box 502, the algorithm may include calculating dimensionless parameters. As previously described, the dimensionless parameters may describe a local flow around an individual perforated exit (e.g., perforation 123) from wellbore 114. The dimensionless parameters may be calculated based on properties of proppant particles (e.g., proppant 116 shown on FIGS. 1 and 2) and fracturing fluid 117. The dimensionless parameters may be calculated with a computer system and may include the parameters Λ an St for the fracture 100. As described above, the parameters Λ an St may be describe a local two phase flow and may be defined by Equation 5. At box 504, the algorithm may include determining proppant collection efficiency R using pre-calculated data. The pre-calculated data may include pre-calculated tables or graphs similar to that in FIG. 4. A computer system may be used to determine the proppant collection efficiency R. At box 506, the algorithm may include calculating the proppant mass flow rate to the fracture 100 based on Equations (2) and (3) as follows:

Q_{pf}=R×Πₗ×Q_{pw} (7)
where Q_{pw} is the total mass flow rate of proppant 116 through wellbore 114, as shown on FIGS. 1 and 2. This algorithm may allow an efficient calculation of the proppant flow rate to individual fractures and perforations based on pre-calculated and tabulated values of the collection efficiency and routine calculation of the liquid flow rates in the system, eliminating the need for corresponding 3D simulations of the proppant transport, which are too CPU-expensive. A proppant collection efficiency calculation may give a prediction about an amount of proppant that may be transported into the perforations. The proppant collection efficiency calculation may help to estimate if there is a sufficient amount of proppant or indicate an insufficient amount of proppant.

The results of Equations (1)-(7) (e.g., mass flow rates of a fracturing fluid, proppant collection efficiency R, dimensionless parameters which may define a local 2-phase flow, particle mass flow rates, Stokes number, proppant mass flow rate, etc.) may be used for calculating proppant transport to fractures (e.g., fractures 100) during a fracking process and estimating, for example, an amount of proppant delivered to individual fractures.

The present disclosure may be implemented through a computer-executable program of instructions, such as program modules, generally referred to as software applications or application programs executed by a computer. The software may include, for example, routines, programs, objects, components and data structures that perform particular tasks or implement particular abstract data types. The software may form an interface to allow a computer to react according to a source of input. The software may be stored and/or carried on any variety of memory such as CD-ROM, magnetic disk, bubble memory and semiconductor memory (e.g. , various types of RAM or ROM). Furthermore, the software and its results may be transmitted over a variety of carrier media such as optical fiber, metallic wire and/or through any of a variety of networks, such as the Internet. Moreover, those skilled in the art will appreciate that the present disclosure may be practiced with a variety of computer-system configurations, including hand-held devices, multiprocessor systems, microprocessor-based or programmable-consumer electronics, minicomputers, mainframe computers, and the like. Any number of computer-systems and computer networks are acceptable for use with the present disclosure. The present disclosure may be practiced in distributed-computing environments where tasks are performed by remote-processing devices that are linked through a communications network. In a distributed-computing environment, program modules may be located in both local and remote computer- storage media including memory storage devices. The present disclosure may therefore, be implemented in connection with various hardware, software or a combination thereof, in a computer system or other processing system.

There may be several programs and/or software packages that may interact to enable the various systems and/or methods of the present disclosure. In some cases, each program and/or software may execute on its own computer system, such as a server computer system, with the interaction occurring by way of network (e g., local area network (LAN), wide area network (WAN), across the Internet). Thus, there may be significant physical distances between the computer systems on which the various tasks are performed. In other cases, two or more programs and/or software packages may execute on the same computer system Further still, some or all of the programs and/or software packages may execute in a “cloud” computing environment, which “cloud” computing environment may be a group of remote server systems which share work load dynamically.

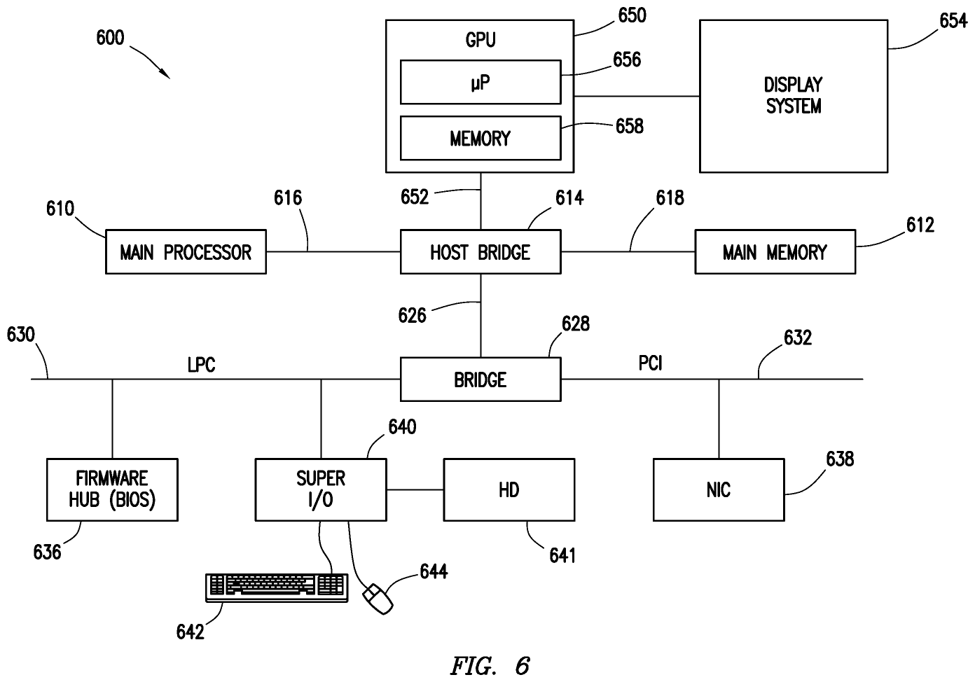

FIG. 6 illustrates a computer system 600 in accordance with at least some systems and/or methods of the present disclosure, and upon which at least some of the various systems and/or methods may be implemented. That is, some or all of the various systems and/or methods may execute on a computer system such as shown in FIG. 6, multiple computers systems such as shown in FIG. 6, and/or one or more computer systems equivalent to the FIG. 6, including after-developed computer systems.

In particular, computer system 600 may comprise a main processor 610 coupled to a main memory 612, and various other peripheral computer system components, through integrated host bridge 614. The main processor 610 may be a single processor core device, or a processor implementing multiple processor cores. Furthermore, computer system 600 may implement multiple main processors 610. The main processor 610 may couple to the host bridge 614 by way of a host bus 616 or the host bridge 614 may be integrated into the main processor 610. Thus, the computer system 600 may implement other bus configurations or bus-bridges in addition to, or in place of, those shown in FIG. 6.

The main memory 612 may couple to the host bridge 614 through a memory bus 618. Thus, the host bridge 614 may comprise a memory control unit that controls transactions to the main memory 612 by asserting control signals for memory accesses. In other systems and/or methods, the main processor 610 may directly implement a memory control unit, and the main memory 612 may couple directly to the main processor 610. The main memory 612 may function as the working memory for the main processor 610 and may comprise a memory device or array of memory devices in which programs, instructions and data may be stored. The main memory 612 may comprise any suitable type of memory such as dynamic random access memory (DRAM) or any of the various types of DRAM devices such as synchronous DRAM (SDRAM) (including double data rate (DDR) SDRAM, double-data-rate two (DDR2) SDRAM, double-data-rate three (DDR3) SDRAM), extended data output DRAM (EDODRAM), or Rambus DRAM (RDRAM). The main memory 612 may be an example of a non-transitory computer-readable medium storing programs and instructions, and other examples are disk drives and flash memory devices. The illustrative computer system 600 also may comprises a bridge device 628 that may bridge the primary expansion bus 626 to various secondary expansion buses, such as a low pin count (LPC) bus 630 and peripheral components interconnect (PCI) bus 632. Various other secondary expansion buses may be supported by the bridge device 628. In accordance with some systems and/or methods, the bridge device 628 may comprise an Input/Output Controller Hub (ICH), and thus the primary expansion bus 626 may comprise a hub-link bus. However, computer system 600 may not be limited to any particular chip set manufacturer, and thus bridge devices and expansion bus protocols from several manufacturers may be equivalently used.

Firmware hub 636 may couple to the bridge device 628 by way of the LPC bus 630. The firmware hub 636 may comprise read-only memory (ROM) which may contain software programs executable by the main processor 610. The computer system 600 may further comprise a network interface card (NIC) 638 illustratively coupled to the PCI bus 632. The NIC 638 may act to couple the computer system 600 to a communication network, such as the Internet.

Still referring to FIG. 6, computer system 600 may further comprise a super input/output (I/O) controller 640 that may be coupled to the bridge device 628 by way of the LPC bus 630. The Super I/O controller 640 may control many computer system functions, for example interfacing with various input and output devices such as, for example, a keyboard 642, a pointing device 644 (e.g., mouse), various serial ports, floppy drives and hard disk drives (HD) 641.

Inputs may be wellbore trajectory, diameter in each location, completion design, liquid properties, such as, for example, density and viscosity, proppant properties such as, for example, density and average diameter, liquid flow rate, proppant pumping rate, proppant volume fraction, wellbore pressure and temperature profiles, perforation design, etc. Proppant collection efficiency parameter may be calculated as an intermediate parameter that may not be shown in a user graphical interface of a software application. The final results may be shown as liquid and proppant mass flow distributions.

The hard disk drives 641 may be another example of a computer-readable media. In other cases, the hard disk drives 641 may couple to a separate drive controller coupled to a more powerful expansion bus, such as the PCI bus 632, particularly in cases where the hard disk drive is implemented as an array of drives (e.g., redundant array of independent (or inexpensive) disks (RAID)). In cases where the computer system 600 may be a server computer system, the keyboard 642, and pointing device 644 may be omitted. The computer system 600 may further comprise a graphics processing unit (GPU) 650 coupled to the host bridge 614 by way of bus 652, such as a PCI Express (PCI-E) bus or Advanced Graphics Processing (AGP) bus. Other bus systems, including after-developed bus systems, may be equivalently used. Moreover, the graphics processing unit 650 may alternatively couple to the primary expansion bus 626, or one of the secondary expansion buses (e.g., PCI bus 632). The graphics processing unit 650 may couple to a display system 654 which may comprise any suitable electronic display device or multiple distinct display devices, upon which any image or text may be displayed. The graphics processing unit 650 may comprise an onboard processor 656, as well as onboard memory 658. The processor 656 may thus perform graphics processing, as commanded by the main processor 610. Moreover, the memory 658 may be significant, on the order of several hundred gigabytes or more. Thus, once commanded by the main processor 610, the graphics processing unit 650 may perform significant calculations regarding graphics to be displayed on the display system, and ultimately display such graphics, without further input or assistance of the main processor 610. In some case, such as the computer system 600 operated as server computer system, the graphics processing unit 650 and display system 654 may be omitted.

From the description provided herein, those skilled in the art are readily able to combine software created as described with appropriate general-purpose or special-purpose computer hardware to create a computer system and/or computer sub-components in accordance with the systems and/or methods of the present disclosure, to create a computer system and/or computer sub-components for carrying out the methods of the present disclosure, and/or to create a non-transitory computer-readable storage medium (i.e., other than an signal traveling along a conductor or carrier wave) for storing a software program to implement the method aspects of the present disclosure.

The systems and methods may include any of the various features of the systems and methods disclosed herein, including one or more of the following statements.

Statement 1: A method may comprise calculating fluid flow with a computer system, wherein the fluid flow is a flow of a fracturing fluid comprising proppant; calculating dimensionless parameters with the computer system, wherein the dimensionless parameters comprise a description of a local flow around an individual perforated exit from a wellbore to a fracture; determining a proppant collection efficiency using pre-calculated data with the computer system; calculating a proppant flow rate to the fracture with the computer system; and calculating with the computer system , an amount of the proppant delivered to the fracture based on one or more of the dimensionless parameters, the proppant collection efficiency, or the proppant flow rate to the fracture.

Statement 2: The method of Statement 1, wherein the calculating a proppant flow rate comprises utilizing Q_{pf}=R×Πₗ×Q_{pw}, wherein Q_{pf} is a particle mass flow rate in the fracture; wherein Q_{pw} is a particle mass flow rate in the wellbore; wherein R is the proppant collection efficiency; wherein Πₗ is a ratio of a mass flow rate of the fracturing fluid in the wellbore to a mass flow rate of the fracturing fluid in the fracture.

Statement 3: The method of Statement 1 or Statement 2, wherein the fracturing fluid further comprises a gelling agent.

Statement 4: The method of any preceding statement, wherein flow of the proppant in the fluid flow has different trajectories than the flow of the fracturing fluid in the fluid flow.

Statement 5: The method of any preceding statement, wherein the computer system is a single phase simulator.

Statement 6: The method of any preceding statement, wherein the fracturing fluid comprises the proppant in an amount of about 10 vol. % or less based on the total volume of the fracturing fluid.

Statement 7: The method of any preceding statement, further comprising displaying on a display device at least one of the proppant collection efficiency, the proppant flow rate, or the description of a local flow around an individual perforated exit from a wellbore.

Statement 8: The method of any preceding statement, wherein the proppant collection efficiency is a function of a fluid flow rate ratio of a flow rate of the fracturing fluid in the wellbore versus a flow rate of the fracturing fluid in the fracture.

Statement 9: The method of any preceding statement, wherein the proppant collection efficiency is calculated for different values of a Stokes number for Newtonian fluids.

Statement 10: A system may comprise a processor; and a memory coupled to the processor, wherein the memory may store a program configured to: calculate a fluid flow, wherein the fluid flow is a flow of a fracturing fluid comprising proppant;

calculate dimensionless parameters; determine a proppant collection efficiency utilizing pre-calculated data; calculate a proppant flow rate to the fracture; and

calculate an amount of the proppant delivered to the fracture based on the fluid flow, the dimensionless parameters, the proppant collection efficiency, and the proppant flow rate to the fracture.

Statement 11: The system of Statement 10, wherein the program is configured to calculate the proppant flow rate by utilizing Q_{pf}=R×Πₗ×Q_{pw}, wherein Q_{pf} is a particle mass flow rate in the fracture; wherein Q_{pw} is a particle mass flow rate in a wellbore; wherein R is the proppant collection efficiency; wherein □ₗ is a ratio of a mass flow rate of the fracturing fluid in the wellbore to a mass flow rate of the fracturing fluid in the fracture.

Statement 12: The system of Statement 10 or Statement 11, wherein flow of the proppant has different trajectories than the flow of the fracturing fluid.

Statement 13: The system of any one of Statements 10 to 12, wherein a concentration of the proppant is less than about 10% by volume of the fracturing fluid.

Statement 14: The system of any one of Statements 10 to 13, wherein the proppant collection efficiency is a function of a fluid flow rate ratio of a flow rate of the fracturing fluid in the wellbore versus a flow rate of the fracturing fluid in the fracture.

Statement 15: The system of any one of Statements 10 to 14, wherein the proppant collection efficiency is calculated for different values of a Stokes number for Newtonian fluids.

Statement 16: The system of any one of Statements 10 to 15, wherein the dimensionless parameters comprise a description of a local flow around an individual perforated exit from a wellbore.

Statement 17: A non-transitory computer-readable media storing a program, wherein the program may be configured to: calculate a fluid flow, wherein the fluid flow is a flow of a fracturing fluid comprising a proppant; calculate dimensionless parameters, wherein the dimensionless parameters comprise a description of a local flow around an individual perforated exit from a wellbore to a fracture; determine a proppant collection efficiency utilizing pre-calculated data; calculate a proppant flow rate to the fracture; and calculate an amount of the proppant delivered to the fracture based on the fluid flow, the dimensionless parameters, the proppant collection efficiency, and the proppant flow rate to the fracture.

Statement 18: The non-transitory computer-readable media storing a program of Statement 17, wherein the program may be configured to calculate the proppant flow rate by utilizing Q_{pf}=R×Πₗ×Q_{pw}, wherein Q_{pf} is a particle mass flow rate in the fracture; wherein Q_{pw} is a particle mass flow rate in a wellbore; wherein R is the proppant collection efficiency; wherein Πₗ is a ratio of a mass flow rate of the fracturing fluid in the wellbore to a mass flow rate of the fracturing fluid in the fracture.

Statement 19: The non-transitory computer-readable media storing a program of Statement 17 or Statement 18, wherein the proppant collection efficiency is a function of a fluid flow rate ratio of a flow rate of the fracturing fluid in the wellbore versus a flow rate of the fracturing fluid in the fracture.

Statement 20: The non-transitory computer-readable media storing a program of any one of Statements 17 to 19, wherein the proppant collection efficiency is calculated for different values of a Stokes number for Newtonian fluids.

To facilitate a better understanding of the present disclosure, the following examples of certain aspects of some of the systems and methods are given. In no way should the following examples be read to limit, or define, the entire scope of the disclosure.

### EXAMPLES

In a demonstrative experiment: a flow of 4% of 0.4 mm sand particle suspension in water flow with velocity V_{lw} 2 m/s in a pipe with internal diameter D_{f}=0.1 m. The fracture 100 (e.g., as shown on FIGS. 1 and 2) may have an inlet diameter 0.01 m and a flow speed of V_{lf}=1.5 m/s. Using the data shown in FIG. 4 for corresponding value of the Stokes number St=4.27 and velocity ratio Λ=0.75, one may find (e.g., with a computer system) the efficiency ratio R=0.83. For the proppant 116 (e.g., shown on FIGS. 1 and 2) flow in the fracture (e.g., fracture 100 shown on FIGS. 1 and 2), Equation (4) in this case yields the average proppant volume concentration α_{pf}=0.83*0.04=0.0332 and the proppant 116 mass flow rate Q_{pf}=3.03×10⁻⁴ kg/s. For a series of consequent fractures 100, the procedure may need to be repeated to yield proppant flow distribution in the whole fracture system (e.g., fractures 100 as shown on FIGS. 1 and 2).

The preceding description provides various examples of the systems and methods of use disclosed herein which may contain different method steps and alternative combinations of components. It should be understood that, although individual examples may be discussed herein, the present disclosure covers all combinations of the disclosed examples, including, without limitation, the different component combinations, method step combinations, and properties of the system. It should be understood that the compositions and methods are described in terms of “comprising,” “containing,” or “including” various components or steps, the compositions and methods can also “consist essentially of” or “consist of” the various components and steps. Moreover, the indefinite articles “a” or “an,” as used in the claims, are defined herein to mean one or more than one of the element that it introduces.

Each of the terms “program” and “software” may refer to executable computer code, groups of executable computer code, or computer code that may become or be used to create execute computer code. Particular components referred to as “programs” in the present disclosure may equivalently be referred to as “software”. Likewise, particular components referred to as “software” in the present disclosure may equivalently be referred to as “programs”. The terminology may be adopted merely to help the reader distinguish different computer codes (or groups of computer code).

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present examples are well adapted to attain the ends and advantages mentioned as well as those that are inherent therein. The particular examples disclosed above are illustrative only, and may be modified and practiced in different but equivalent manners apparent to those skilled in the art having the benefit of the teachings herein. Although individual examples are discussed, the disclosure covers all combinations of all of the examples. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative examples disclosed above may be altered or modified and all such variations are considered within the scope and spirit of those examples. If there is any conflict in the usages of a word or term in the present disclosure and one or more patent(s) or other documents that may be incorporated herein by reference, the definitions that are consistent with the present disclosure should be adopted.

What is claimed is:

1. A method comprising:
calculating fluid flow with a computer system, wherein the fluid flow is a flow of a fracturing fluid comprising proppant;
calculating dimensionless parameters with the computer system, wherein the dimensionless parameters comprise a description of a local flow around an individual perforated exit from a wellbore to a fracture;
determining a proppant collection efficiency using pre-calculated data with the computer system;
calculating a proppant flow rate to the fracture with the computer system; and
calculating with the computer system , an amount of the proppant delivered to the fracture based on the dimensionless parameters, the proppant collection efficiency, or the proppant flow rate to the fracture.

2. The method of claim 1, wherein the calculating a proppant flow rate comprises utilizing Q_{pf}=R×Πₗ×Q_{pw}, wherein Q_{pf} is a particle mass flow rate in the fracture; wherein Q_{pw} is a particle mass flow rate in the wellbore; wherein R is the proppant collection efficiency; and wherein Πₗ is a ratio of a mass flow rate of the fracturing fluid in the wellbore to a mass flow rate of the fracturing fluid in the fracture.

3. The method of claim 1, wherein the fracturing fluid further comprises a gelling agent.

4. The method of claim 1, wherein flow of the proppant in the fluid flow has different trajectories than the flow of the fracturing fluid in the fluid flow.

5. The method of claim 1, wherein the computer system is a single phase simulator.

6. The method of claim 1, wherein the fracturing fluid comprises the proppant in an amount of about 10 vol. % or less based on the total volume of the fracturing fluid.

7. The method of claim 1, further comprising displaying on a display device at least one of the proppant collection efficiency, the proppant flow rate, or the description of the local flow around the individual perforated exit from the wellbore.

8. The method of claim 1, wherein the proppant collection efficiency is a function of a fluid flow rate ratio of a flow rate of the fracturing fluid in the wellbore versus a flow rate of the fracturing fluid in the fracture.

9. The method of claim 8, wherein the proppant collection efficiency is calculated for different values of a Stokes number for Newtonian fluids.

10. A system comprising:
a processor; and
a memory coupled to the processor, wherein the memory stores a program configured to:
calculate a fluid flow, wherein the fluid flow is a flow of a fracturing fluid comprising proppant;
calculate dimensionless parameters;
determine a proppant collection efficiency utilizing pre-calculated data;
calculate a proppant flow rate to a fracture; and
calculate an amount of the proppant delivered to the fracture based on the fluid flow, the dimensionless parameters, the proppant collection efficiency, and the proppant flow rate to the fracture.

11. The system of claim 10, wherein the program is configured to calculate the proppant flow rate by utilizing Q_{pf}=R×Πₗ×Q_{pw}, wherein Q_{pf} is a particle mass flow rate in the fracture; wherein Q_{pw} is a particle mass flow rate in a wellbore; wherein R is the proppant collection efficiency; and wherein Πₗ is a ratio of a mass flow rate of the fracturing fluid in the wellbore to a mass flow rate of the fracturing fluid in the fracture.

12. The system of claim 10, wherein flow of the proppant has different trajectories than the flow of the fracturing fluid.

13. The system of claim 10, wherein a concentration of the proppant in the fracturing fluid is less than about 10% by volume of the fracturing fluid.

14. The system of claim 10, wherein the proppant collection efficiency is a function of a fluid flow rate ratio of a flow rate of the fracturing fluid in a wellbore versus a flow rate of the fracturing fluid in the fracture.

15. The system of claim 14, wherein the proppant collection efficiency is calculated for different values of a Stokes number for Newtonian fluids.

16. The system of claim 10, wherein the dimensionless parameters comprise a description of a local flow around an individual perforated exit from a wellbore.

17. A non-transitory computer-readable media storing a program, wherein the program is configured to:
calculate a fluid flow, wherein the fluid flow is a flow of a fracturing fluid comprising a proppant;
calculate dimensionless parameters, wherein the dimensionless parameters comprise a description of a local flow around an individual perforated exit from a wellbore to a fracture;
determine a proppant collection efficiency utilizing pre-calculated data;
calculate a proppant flow rate to the fracture; and
calculate an amount of the proppant delivered to the fracture based on the fluid flow, the dimensionless parameters, the proppant collection efficiency, and the proppant flow rate to the fracture.

18. The non-transitory computer-readable media of claim 17, wherein the program is configured to calculate the proppant flow rate by utilizing Q_{pf}=R×Πₗ×Q_{pw}, wherein Q_{pf} is a particle mass flow rate in the fracture; wherein Q_{pw} is a particle mass flow rate in a wellbore; wherein R is the proppant collection efficiency; wherein Πₗ is a ratio of a mass flow rate of the fracturing fluid in the wellbore to a mass flow rate of the fracturing fluid in the fracture.

19. The non-transitory computer-readable media of claim 18, wherein the proppant collection efficiency is a function of a fluid flow rate ratio of a flow rate of the fracturing fluid in the wellbore versus a flow rate of the fracturing fluid in the fracture.

20. The non-transitory computer-readable media of claim 19, wherein the proppant collection efficiency is calculated for different values of a Stokes number for Newtonian fluids.

21.-35. (canceled)
